(19) United States
(12) Patent Application Publication
(10) Pub. No.: US 2004/0066374 A1
(43) Pub. Date: Apr. 8, 2004

(54) Keyboard configurable to multiple mappings

(75) Inventors: Lane Thomas Holloway, Pflugerville, TX (US); Nadeem Malik, Austin, TX (US); Marques Benjamin Quiller, Pflugerville, TX (US)

Correspondence Address: Mark D. Simpson, Esq., SYNNESTVEDT & LECHNER LLP, Aramark Tower, Suite 2600, 1101 Market Street, Philadelphia, PA, 19107, US

(73) Assignee: International Business Machines Corporation, Armonk, NY

(21) Appl. No.: 10/264,164

(22) Filed: Oct. 3, 2002

(51) Int. Cl. G09G 5/00

(52) U.S. Cl. 345/168

(57) ABSTRACT

A keyboard having keys in or on which are situated changeable display elements, e.g., LCD, LED, LEP or the like, so that an image displayed on the display element is viewable on the keycap surface by a user. A keyboard mapping is changeable to an alternative mapping via the use of one or more mapping control keys, and the indicia displayed on the keys of the keyboard are changed electronically to correspond to the selected keyboard mapping

### BACKGROUND OF THE INVENTION

1. Field of the Invention

This invention relates in general to data processing systems and in particular to data processing entry systems such as computer keyboards. Still more particularly, the invention relates to computer keyboards that are configurable to multiple keyboard mappings.

2. Description of the Related Art

A keyboard is that part of a computer system that resembles a typewriter keyboard and enables a user to control certain aspects of the computer. All computer keyboards include a standard set of manipulatable keys mounted in a keyboard housing that can be independent from the system with which it operates (e.g., a typical desktop computer keyboard) or that is integrated with the system itself (e.g., a typical laptop computer keyboard). Each key typically corresponds to a particular letter, number, symbol, or function. Each key on a typical keyboard comprises a combination of a plastic keycap, a tension mechanism that suspends the keycap but allows it to be pressed down, and an electronic mechanism that records the key press and key release.

Typically a character or series of characters are printed on the face of the keycap to identify the function of that particular key. Most keys are multi-function keys, meaning that they can be toggled (shifted) between two or more operations (e.g., upper case “A” and lower case “a”; the number “7” and the symbol “&”, etc.) typically through the use of a “shift” key.

Some keyboards are equipped with keys that include electrical wiring extending up into the keycap to illuminate a lamp or other indicator mechanism in the key. An example of such a key can be found in the Powerbook Ti made by Apple Computers, which includes LEDs in the “CAPS LOCK” keycap to show if the CAPS LOCK function is engaged. Others have developed back-lighting systems for delivering light to the keycap area of the keyboard. U.S. Pat. No. 5,034,602 to Garcia, Jr. et al. teaches an optically activated keyboard having key members, each with a keycap having illuminated symbols at the keycap surface. Various methods of lighting the keycap are described in Garcia, including the passing of light through a plunger beneath the keycap to a removable template containing the character corresponding to the key configuration. Further, Garcia discloses the concept of placing a symbol generating LED or LCD device beneath a waveguide underneath the keycap to project a symbol via the waveguide to the surface of the keycap. The symbol generating device can be programmed to provide any predetermined symbol capable of being formed, thus providing a changeable keycap symbol capability.

Designers are always looking for ways to decrease the size of computer components, and keyboards are no exception. Particularly with the prevalence of laptop and hand-held computers, designers of computer keyboards place great emphasis on size reduction and maximizing the use of existing keys. Thus, for example, rather than having a separate numeric keypad in the traditional “adding machine” configuration, virtually all laptop computers and many desktop computers have keyboards that utilize the “num lock” key which, when activated, changes the function of certain dual-function alpha-numeric keys to a third function, i.e., emulating the numeric keyboard.

Today's keyboards contain many additional keys beyond the traditional alpha-numeric keys. A typical desktop keyboard may have over 100 keys, and a typical laptop keyboard may have 85 keys as well as dedicated keys for functions such as volume control. Function keys, “page up” and “page down” keys, “home”, etc. all find their place on typical keyboards in use today. “Ctrl” and “Alt” keys act like additional “shift” keys, designating different functions to keys or sequences of keys when they are depressed simultaneously with the “Ctrl” and/or “Alt” keys.

While the use of function keys and shift-type keys give designers the ability to decrease the number of keys on a keyboard and/or maximize the use of keyboard space, such keyboard systems still have drawbacks. For example, function keys are typically labeled simply “F1”, “F2”, “F3”, . . . etc. and thus require the user to remember the function performed by the function key or use a separate template to refer to when using the function keys. This makes use of the function keys more difficult, particularly for someone not familiar with the function keys' operations.

Similarly, most multi-function keys must be labeled with both functions directly on the keycap. For example, an IBM ThinkPad® computer utilizes the shift and “num lock” keys simultaneously to toggle alpha-numeric keys between their regular dual-function use and their use as a keypad. Thus, the “J”, “K”, “L” keys also have their numeric counterparts, “1”, “2”, “3”, respectively, written directly on the keypad for use by the user. In certain instances, all three function indicias must be squeezed onto the same key (e.g., 0, ), and /). This can be confusing and limits the number of functions that can be easily performed by the key, since there is a limited amount of space on the keypad on which to write the functions to be performed by the key. To make matters more complex, when the ThinkPad® keyboard has the numeric keypad enabled, pressing and holding the shift key toggles the numeric keys to switch to curser control (e.g., move right, move left, etc.) and screen controls (e.g., page down, page up, etc.). These control functions are not written on the keycaps, requiring the user to remember the function of the keys when in the cursor/page control mode.

Accordingly, it is desirable to have a single keyboard that can be reconfigured electronically to provide alternate keyboard layouts quickly, easily, and without the requirement of having additional keyboards available for use, and that can switch the indicia on the keycap to match the function of a key at any given time.

### SUMMARY OF THE INVENTION

The present invention is a keyboard having keys in or on which are situated 15 changeable display elements, e.g., LCD, LED, LEP or the like, so that an image displayed on the display element is viewable on the keycap surface by a user. A keyboard mapping is changeable to an alternative mapping via the use of one or more mapping control keys, and the indicia displayed on the keys of the keyboard are changed electronically to correspond to the selected keyboard mapping. Thus, for example, a standard keyboard layout can be modified so that less-often-used keys such as the “function keys” are removed. When the function keys are needed, the user can select a function-key keyboard mapping to switch the display on a row of alpha-numeric keys to instead display a row of function keys. The user may see indicia of the function performed by the various keys when the function-key keyboard mapping is selected (e.g., “help”), directly on the keycaps or, alternatively, they may see the standard “F1,” “F2,” “F3” . . . , etc. notation on the keycap. Similarly, a user can select a completely different keyboard layout (e.g., DVORAK) such that changing the keyboard mapping to DVORAK will actually display the DVORAK keyboard directly on the keycaps of the same keyboard.

### BRIEF DESCRIPTION OF THE DRAWINGS

FIG. 1 illustrates a keyboard layout for a typical IBM ThinkPad® laptop computer;

FIG. 2 illustrates a reduced-key keyboard layout in accordance with the present invention;

FIG. 3 illustrates the keyboard illustrated in FIG. 2, with an alternative keyboard mapping displayed on the keys;

FIG. 4 is a cross-sectional view of a keycap in accordance with the present invention;

FIGS. 5 and 6 illustrate two different displays being displayed on the same keycap in accordance with the present invention; and

FIG. 7 is a flowchart illustrating the basic steps performed for controlling the mapping and display function of a keyboard in accordance with the present invention.

### DETAILED DESCRIPTION OF THE PREFERRED EMBODIMENTS

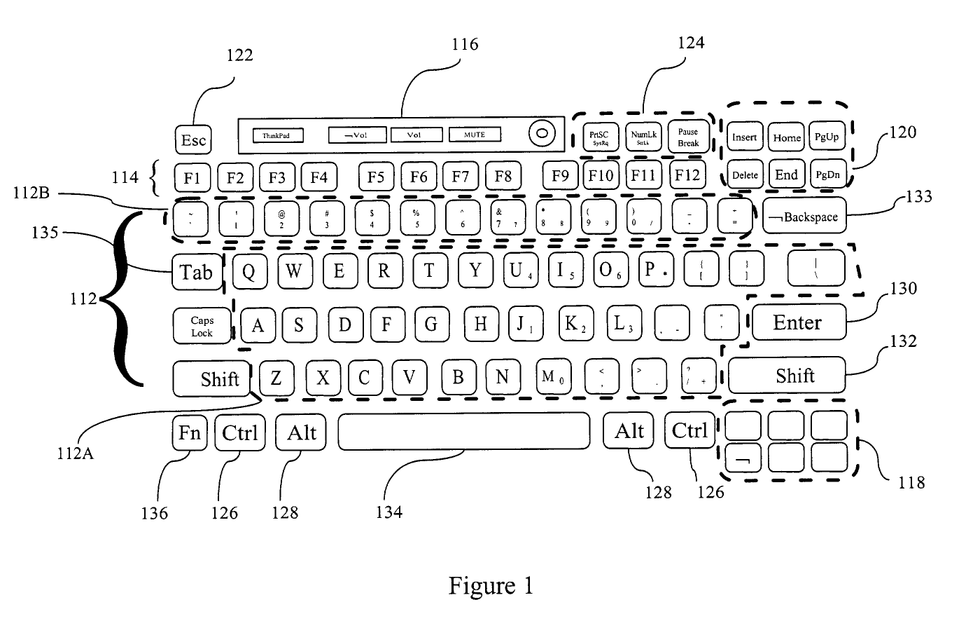

With reference now to the figures, in FIG. 1, there is depicted a keyboard layout for a typical IBM ThinkPad® laptop computer. It is understood that this particular keyboard configuration is illustrated for purposes of example only, and that the present invention is equally applicable to any keyboard layout.

Referring to FIG. 1, keyboard 110 includes a block of alphanumeric keys 112, a group of function keys 114, control keys 116, cursor-control keys 118, screen/text control keys 120, “escape” key 122, and miscellaneous operational keys 124. The alphanumeric block 112 includes the alphabet/primary-punctuation keys 112A; the numeric keys 112B; and primary control keys comprising “Ctrl” keys 126, “Alt” keys 128, the “Enter” key 128, shift keys 132, the “Backspace” key 133, the space bar 134, and the “Tab” key 135.

The Ctrl keys 126, Alt keys 128, and shift keys 132 provide, in a well known manner, the ability to provide alternate operation for various keys along the keyboard. The Enter key 130, space bar 134, Backspace key 133, and Tab key 135 function in a well known manner to control the movement of a cursor displayed on a system to which the keyboard is operatively coupled. In addition, the ThinkPad® computer also has a “Fn” key 136, the operation of which will be described below.

The function keys 114 are software-specific, that is, they operate based upon the program presently running on the computer. For example, in a word processing program, pressing the “F1” function key might bring up a help menu; pressing the Ctrl key 126 with the “F1” key might run a spell-checking function; pressing the Alt key 128 with the “F1” key might run a Thesaurus function; and pressing the Shift key 132 with the “F1” key might perform a grammar checking function. The same keys activated during the operation of a computer game might cause the firing of a weapon used in the game; the pausing of game play; display of a “save” menu; and display of the current high score, respectively. The Ctrl keys 126 and Alt keys 128 function in a manner similar to the shift key 132; that is, by depressing the control key in connection with the simultaneous depressing of an alphanumeric key or function key, the depressed key will perform a different function than its ordinary function, assuming that the program being operated has been configured to operate in this manner. Thus, the function keys 114 provide for customizable functions based on the program, the Ctrl keys 126 and Alt keys 128 provide the ability to expand the function of all keys beyond the designation imprinted upon the keycap, and the Shift keys 132 provide dual functionality to most “regular” keys and additional functionality to the function keys 114.

The Fn key 136 is provided on the ThinkPad® computer to provide additional computer-specific functionality options not available using a function key or a function key in connection with the Shift, Ctrl, or Alt keys. Thus, in the example above, where the “F1” key and the Shift, Ctrl, and Alt keys are used to provide four functions for one key, the addition of the Fn key 136 extends that to a fifth function. For example, the F4 key of a ThinkPad® computer is imprinted with a small symbol of a computer screen and a crescent moon, in addition to the F4 designation. When the F4 key is pressed simultaneously with the Fn key, this puts the computer screen into a sleep mode that saves battery power. Obviously, designers could add additional keys similar to the Fn, Ctrl, Alt, and Shift keys and thereby obtain more functionality. However, typically it is more desirable to reduce the number of keys while maintaining or increasing the functionality available.

Control keys 116 are simply special purpose pre-designated keys to perform specific operations that a user of the PC might be called upon to use quickly, though not necessarily frequently. These keys are computer-specific and function the same regardless as to which program is running on the system at the time. These controls include volume controls and one-button access to help information regarding ThinkPad® computers.

Clearly the alphanumeric keys 112 are the most heavily used keys on the keyboard (and, more specifically, the alphabet/primary-punctuation keys 112A), and in most situations it would be desirable for these keys to be visible to the user at all times. However, many of the keys receive infrequent use. For example, the function keys 114, the escape key 122, the control keys 116, the operational keys 124, and the screen/text control keys 120 all are used only for specific situations that may not occur with great frequency. Thus, there is less of a need for these keys to be visible and available at all times to the user. However, up until the development of the present invention, designers were required to include these less-used keys as part of the physical keyboard or lose their functionality.

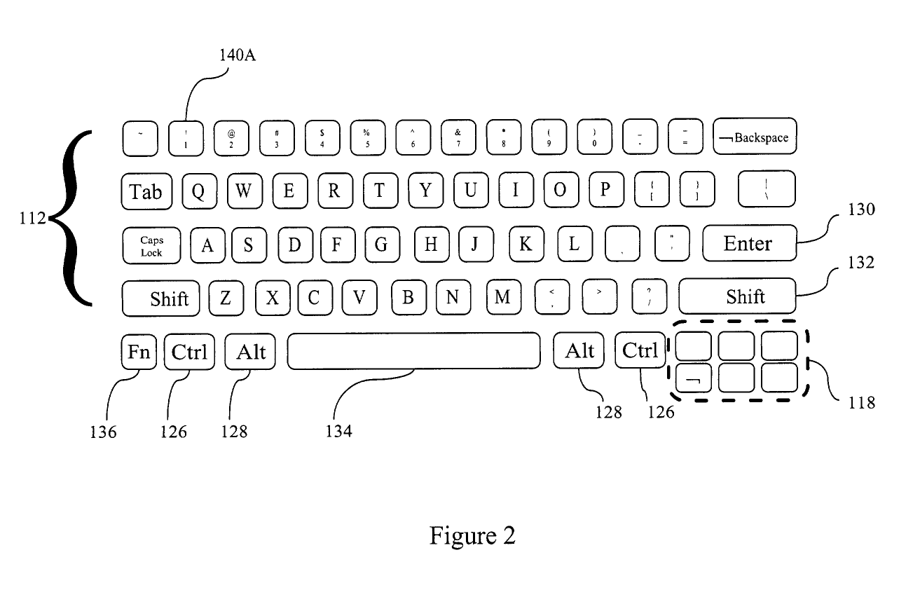

Referring now to FIG. 2, a keyboard layout in accordance with the present invention is illustrated. As can be seen in FIG. 2, function keys 114, escape key 124, control keys 116, operational keys 122, and text manipulation keys 120 have all been removed. In addition, the numeric keypad indicia are not visible on the keycaps. This is made possible by fabricating the keys so that the permanently inscribed keypads of the prior art are replaced with keypads whereby the indicia information is displayed on the top of the keycap using small membrane, light-emitting polymer (LEP), LED, LCD, or other thin-screen technology display elements. By placing display elements in the keycaps themselves (or fabricating the keys so that the images on display elements situated beneath the keys are viewable on the surface of the keycap as in the previously-referenced Garcia, Jr. et al. patent) a different image can be displayed on a particular keycap, depending upon the function of the keycap at that time. As described below, control of the display (and the keyboard functionality) is accomplished through the use of mapping control (MC) keys in connection with appropriate keyboard drivers.

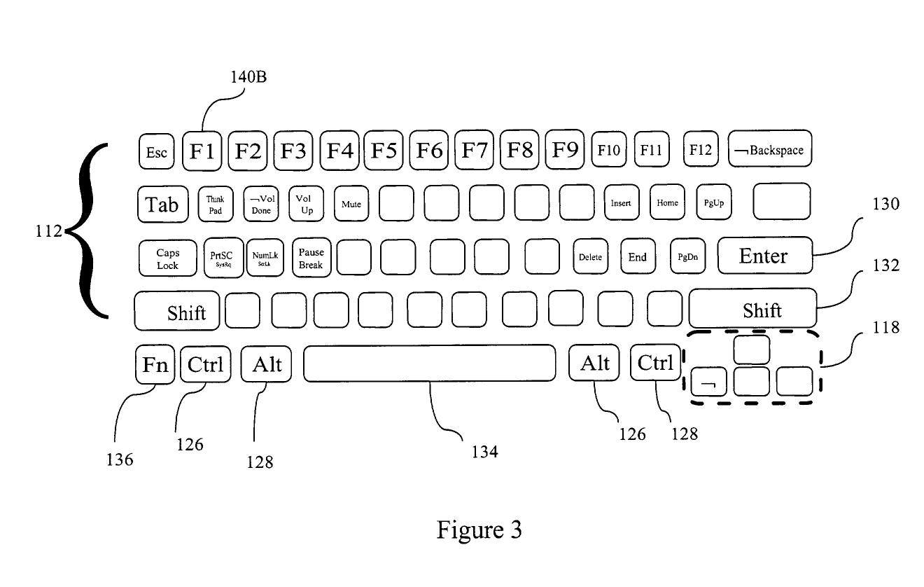

This novel functionality makes possible the reduced-key keyboard illustrated in FIG. 2. This primary key mapping would typically be displayed upon booting up of the machine, I.e., it would be the default keyboard mapping. In order to achieve the function of the function keys that have been removed, the user can, for example, depress a “mapping control” (“MC”) key, e.g., the Fn key 136, thereby instructing the keyboard driver to change the keyboard mapping and display the keyboard mapping shown in FIG. 3. As can be seen in FIG. 3, the top row of the keyboard of FIG. 2, which in this example would normally display various typographical characters and numerical characters, instead has changed to show the escape function and the function keys F1 through F12. The control keys 116 are now displayed in the second row, the operational keys 124 are now displayed in the third row, and the screen/text control keys 120 are displayed in the second and third rows from the top on the right-hand side of the keyboard.

In a known manner, keyboard drivers can be written and installed that change the keyboard mapping to alternate mappings, activated by, for example, the actuating of a key or keys dedicated for this purpose. For example, the Fn key 136 could serve as an MC key to activate the mapping for the keyboard illustrated in FIG. 3, and the Fn key 136 could be used simultaneously with the Ctrl key 126 to activate a different mapping (e.g., the numeric keyboard). Alternatively, the Fn key 136 could be configured to “scroll” through all available keyboard mappings, with each press of the key advancing forward one selection in a selection list of keyboard mappings (and displaying on the keys each mapping as it is selected). Numerous ways to select form the alternate keyboard mappings will be apparent to those of ordinary skill in the art; the above are but two examples.

The Fn key 136, Ctrl keys 126, and/or Alt keys 128 may all serve as MC keys. It is understood that additional MC keys could be added to the keyboard if needed.

In accordance with the present invention, a keyboard can be configured that uses the optimal minimum number of keys without losing the functionality of a larger keyboard. Thus, for example, if it is determined that the numeric and typographical characters along the top row of alpha-numeric characters 112 of FIG. 1 are rarely used, they too can be removed, reducing the keyboard size even further. Then, when needed, they can be activated and actively displayed on the keyboard simply by manipulating a function key or series of control keys identifying that keyboard map. Similarly, a keyboard can be changed from one language to an entirely different language and back again simply by the press of a key, as long as there are sufficient keys to support the language. Similarly, a user could switch between a DVORAK and QWERTY keyboard, thus obviating the need to have an alternate keyboard available when switching between the two.

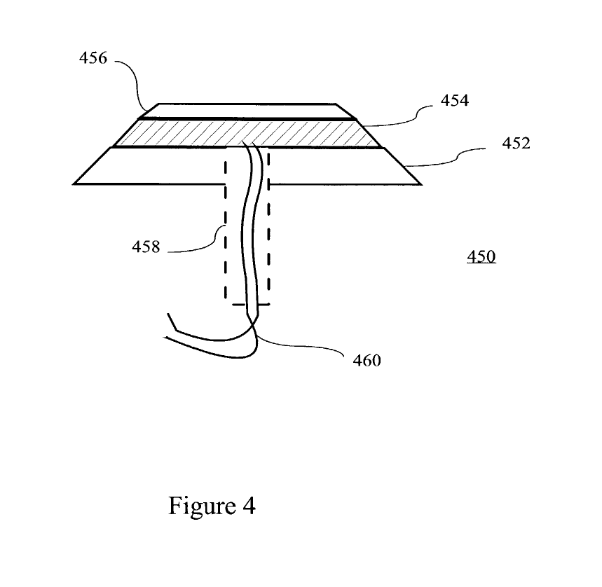

FIG. 4 illustrates a keycap 450, referred to as a “configurable keycap”, which can function with the present invention to provide the required functionality. Referring to FIG. 4, the keycap 450 comprises a lower cap 452 having a plunger 458 connected thereto in a well-known manner. This plunger/cap combination is a well-known configuration for typical keycaps used in keyboards. A display element layer 454 is situated atop the lower cap 452 and receives power and control functions via wires 460. Wires 460 extend through the plunger 458 from the display element layer 454, thereby placing them in appropriate location to receive power and control signals. Display element layer 454 can comprise any flexible display material, such as LEP, “electronic ink” technology, LCD, LED, or similar flexible display technology.

To protect the flexible screen material serving as the display element layer 454, a plastic cover 456 can be affixed to the display element layer 454 and/or to the lower cap 452 using any known method, including glues, adhesives, or by providing an interlock between the plastic cover 456 and the lower cap portion 452 in such a way as to hold the display element layer 454 therebetween. The example shown in FIG. 4 is merely one example of a method for providing individually configurable keycaps. It is understood that any known means for displaying images on keycaps, including those disclosed in Garcia, Jr. et al., will function for the purpose of the present invention.

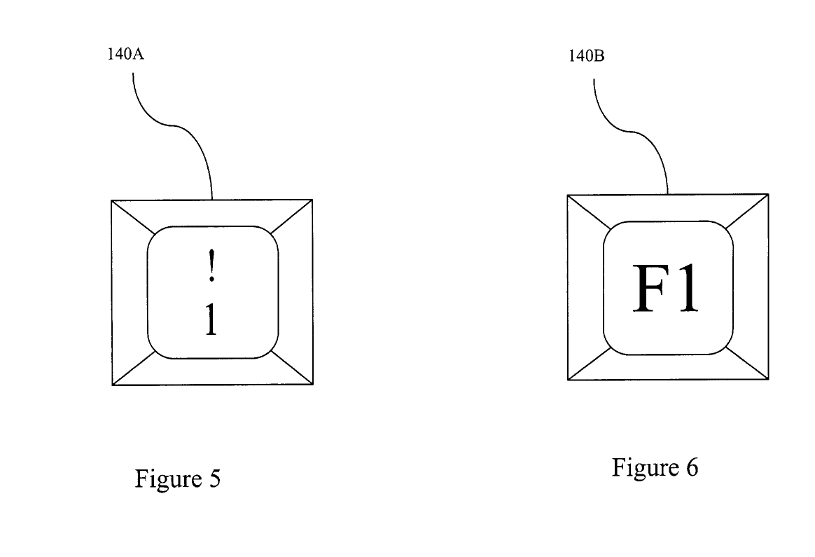

FIGS. 5 and 6 illustrate two different displays being displayed on the same keycap. In FIG. 5, keycap 140A (see FIG. 2) shows the normal “1” key, and the alternate “!” that functions when key 140 is depressed with the Shift key. FIG. 6 illustrates the same key (labeled 140B to conform to FIG. 3), as it would appear when an MC key is selected that selects the keyboard mapping illustrated in FIG. 3. While the example of FIG. 6 shows the marking “F1” displayed on the keycap, known programming techniques could be used to instead have a descriptive term (e.g., “Help”) displayed that would give the user a better idea as to the function of keycap 140B.

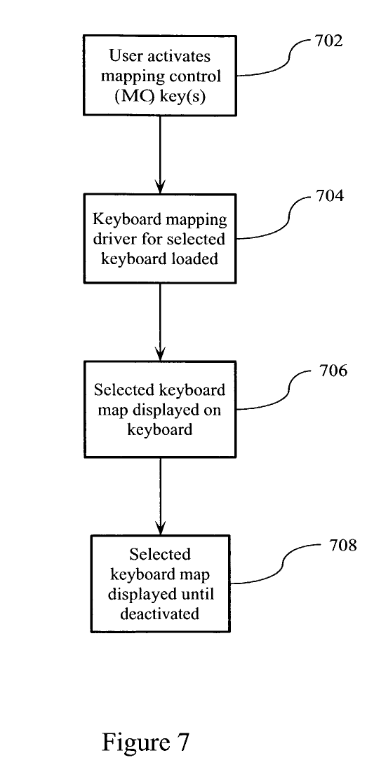

FIG. 7 is a flowchart illustrating the basic steps of the present invention. At step 702, a user activates a particular mapping control (MC) key. There could be several MC keys and there could be several combinations that form additional MC keys, for example, the Fn, Ctrl, Alt, and Shift keys could each be MC keys, as could combinations thereof to allow additional keyboard maps.

At step 704, the keyboard mapping driver associated with the MC key activated is loaded and, at step 706, the keyboard mapping is changed to reflect the selection and the selected keyboard map is displayed on the keyboard itself. Virtually any desired keyboard map could be displayed. Known programming techniques can be used to change the keyboard mapping and display the desired keycap images based on the particular MC key activated.

As illustrated by step 708, the selected keyboard map continues to be displayed until deactivated. The process for deactivating the selected keyboard map can be as simple as letting go of the MC key, i.e., it only displays the selected keyboard when it is depressed. Alternatively, the MC keys can operate similar to the “CAPS LOCK” key on a typical keyboard, whereby depressing the MC key a first time activates the selected keyboard map, and it will remain activated until the MC key is pressed a second time. Further, as noted above, the MC key could be configured to scroll sequentially through each available keyboard mapping associated with the particular MC key.

The above-described steps can be implemented using standard well-known programming techniques in connection with a keyboard modified to include configurable keycaps. The novelty of the above-described embodiment lies not in the specific programming techniques but in the use of the steps described to achieve the described results. Software programming code which embodies the present invention is typically stored in permanent storage of some type, such as permanent storage of the workstation to which the keyboard is attached. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A configurable keyboard, comprising:
a keyboard housing;
a plurality of keys, mounted in said keyboard housing, with one or more of said keys having programmable-display keycaps; and
a storage device, operatively connectable to said plurality of keys, storing program instructions executable to select a keyboard mapping for said keyboard from a plurality of keyboard mappings and simultaneously displaying indicia of said selected keyboard mapping on said programmable-display keycaps.

2. A configurable keyboard as set forth in claim 1, wherein said keyboard includes one or more mapping control (MC) keys, and wherein said program instructions are executed upon activation of at least one of said MC keys.

3. A configurable keyboard as set forth in claim 2, wherein the number of keys of said keyboard is limited to the number of keys required to implement a predetermined primary keyboard mapping.

4. A configurable keyboard as set forth in claim 3, wherein said predetermined primary keyboard mapping is limited to keys in the alphabet block and the primary control keys.

5. A configurable keyboard as set forth in claim 3, wherein said predetermined primary keyboard mapping is limited to the alphanumeric block and the primary control keys.

6. A configurable keyboard as set forth in claim 3, wherein said plurality of keyboard mappings includes said primary keyboard mapping and at least one secondary keyboard mapping, and wherein said at lest one secondary keyboard mapping comprises one or more function keys.

7. A configurable keyboard as set forth in claim 6, wherein the indicia displayed on said programmable-display keycaps associated with said one or more function keys comprises one or more words identifying a function executed upon actuation of said one or more function keys.

8. A configurable keyboard as set forth in claim 3, wherein said plurality of keyboard mappings includes said primary keyboard mapping and at least one secondary keyboard mapping, and wherein said primary keyboard mapping comprises the alphabet block associated with the QWERTY keyboard.

9. A configurable keyboard as set forth in claim 8, wherein said at least one secondary keyboard mapping comprises the alphabet block associated with the DVORAK keyboard.

10. A configurable keyboard as set forth in claim 3, wherein said plurality of keyboard mappings includes said primary keyboard mapping and at least one secondary keyboard mapping, and wherein said primary keyboard mapping comprises an alphabet block associated with a first language and wherein said at least one secondary keyboard mapping comprises an alphabet block associated with a second language.

11. A processing system, comprising:
a central processing unit;
a storage medium coupled to said central processing unit;
a keyboard coupled to said central processing unit, said keyboard having configurable keys, with one or more of said keys having programmable-display keycaps; and
program instructions stored on said storage medium, said program instructions executable to select a keyboard mapping for said keyboard from a plurality of keyboard mappings and simultaneously displaying indicia of said selected keyboard mapping on said programmable-display keycaps.

12. A processing system as set forth in claim 11, wherein said keyboard includes one or more mapping control (MC) keys, and wherein said program instructions are executed upon activation of at least one of said MC keys.

13. A processing system as set forth in claim 12, wherein the number of keys of said keyboard is limited to the number of keys required to implement a predetermined primary keyboard mapping.

14. A processing system as set forth in claim 13, wherein said predetermined primary keyboard mapping is limited to keys in the alphabet block and the primary control keys.

15. A processing system as set forth in claim 13, wherein said predetermined primary keyboard mapping is limited to the alphanumeric block and the primary control keys.

16. Computer-readable code stored on media for selecting a keyboard mapping for a keyboard having programmable-display keycaps, comprising:
first subprocesses for implementing a predetermined primary keyboard mapping;
second subprocesses for implementing an alternate keyboard mapping from a plurality of keyboard mapping selections; and
third subprocesses for displaying, on said programmable-display keycaps, indicia of a keyboard mapping selected from said primary keyboard mappings or one of said alternate keyboard mappings.
